(19) United States
(12) Patent Application Publication
(10) Pub. No.: US 2017/0129805 A1
(43) Pub. Date: May 11, 2017

(54) ENHANCED BLIND COVER AND METHOD FOR FABRICATING THE SAME

(71) Applicants: INTERFACE OPTOELECTRONICS (SHENZHEN) CO., LTD., GUANGDONG (CN); GENERAL INTERFACE SOLUTION LIMITED, MIAOLI COUNTY (TW)

(72) Inventors: CHUNG-WU LIU, GUANGDONG (CN); CHUN-TE CHANG, GUANGDONG (CN)

(21) Appl. No.: 14/988,011

(22) Filed: Jan. 5, 2016

(30) Foreign Application Priority Data
Nov. 11, 2015 (CN) 201510768301.3

(51) Int. Cl. C03C 17/32; C03C 15/00

(52) U.S. Cl. CPC C03C 17/32; C03C 15/00; C03C 2218/112

(57) ABSTRACT

An enhanced blind cover and a method for fabricating the same is disclosed. Firstly, a cover having at least one blind hole is provided. Then, liquidized protection glue is formed on an inner sidewall and an inner bottom surface of the blind hole. Finally, the liquidized protection glue is solidified to form solidified protection glue.

This application claims priority for China patent application no. 201510768301.3 filed on Nov. 11, 2015, the content of which is incorporated by reference in its entirely.

### BACKGROUND OF THE INVENTION

Field of the Invention

The present invention relates to a cover fabrication technology, particularly to an enhanced blind cover and a method for fabricating the same.

Description of the Related Art

With technological advancements, hand-held electronic devices such as smart phones or tablet computers have widely applied to daily life. Although the hand-held electronic devices are more and more popular, the hand-held electronic devices have the opportunity to drop to the ground compared with desk-top computers. As a result, the hardness of the external cover of the hand-held electronic device becomes very important. If the hardness is not insufficient, the external cover will break to affect its appearance when the hand-held electronic device drops to the ground.

In the traditional technology, a touch module is composed of a sensor glass, a cover glass and a sensing circuit between them. In general, the cover glass has blind holes. The blind hole is inserted with a fixed pillar to combine with other elements. In order to improve the hardness of the cover glass, an enhanced fabrication process is performed on the cover glass one time whereby compression stress of the surface of the cover glass increases. For example, after the glass is heated to softening temperature, the glass cools down rapidly so that the surface of the glass is compressed to improve its hardness. This is because the compression stress of the glass surface and a central layer of the glass are balanced to form sufficient tension. However, even if the enhanced fabrication process is performed, broken points appear on the edge of the blind holes. Thus, the hardness of the cover glass is not sufficient and the cover glass is not used.

To overcome the abovementioned problems, the present invention provides an enhanced blind cover and a method for fabricating the same, so as to solve the afore-mentioned problems of the prior art.

### SUMMARY OF THE INVENTION

A primary objective of the present invention is to provide an enhanced blind cover and a method for fabricating the same, which forms solidified protection glue on an inner sidewall and an inner bottom surface of the blind hole of a cover, thereby improving hardness of the blind hole.

To achieve the abovementioned objectives, the present invention provides an enhanced blind cover, which comprises a cover and solidified protection glue. The cover has at least one blind hole. The solidified protection glue is arranged on an inner sidewall and an inner bottom surface of the blind hole.

The present invention also provides a method for fabricating an enhanced cover. Firstly, a cover having at least one blind hole is provided. Then, liquidized protection glue is formed on an inner sidewall and an inner bottom surface of the blind hole. Finally, the liquidized protection glue is solidified to form solidified protection glue.

Below, the embodiments are described in detail in cooperation with the drawings to make easily understood the technical contents, characteristics and accomplishments of the present invention.

### BRIEF DESCRIPTION OF THE DRAWINGS

FIG. 1 is a diagram schematically showing an enhanced cover according to the first embodiment of the present invention;

FIG. 2 is a sectional view taken along Line A-A′ of FIG. 1 of the present invention;

FIGS. 3(a)-3(d) are diagrams schematically showing the steps of fabricating the enhanced cover according to the first embodiment of the present invention;

FIG. 4 is a diagram schematically showing an enhanced cover according to the second embodiment of the present invention;

FIG. 5 is a sectional view taken along Line B-B′ of FIG. 4 of the present invention;

FIGS. 6(a)-6(d) are diagrams schematically showing the steps of fabricating the enhanced cover according to the second embodiment of the present invention;

FIG. 7 is a diagram schematically showing an enhanced cover according to the third embodiment of the present invention;

FIG. 8 is a sectional view taken along Line C-C′ of FIG. 7 of the present invention; and

FIGS. 9(a)-9(d) are diagrams schematically showing the steps of fabricating the enhanced cover according to the third embodiment of the present invention.

### DETAILED DESCRIPTION OF THE INVENTION

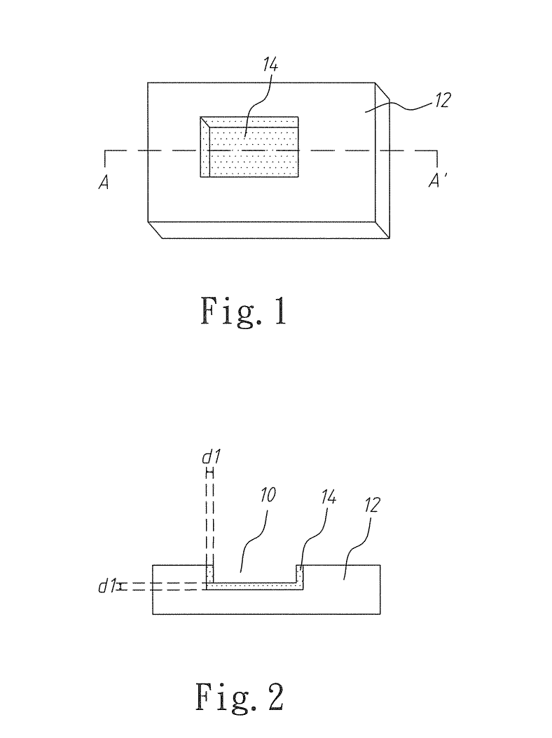

The first embodiment of the present invention is introduced as below. Refer to FIG. 1 and FIG. 2. The enhanced cover of the present invention comprises a cover 12 and solidified protection glue 14, wherein the cover 12 has at least one blind hole 10. The solidified protection glue 14 is arranged on an inner sidewall and an inner bottom surface of the blind hole 10. For design, the solidified protection glue 14 arranged on the inner sidewall and the inner bottom surface of the blind hole 10 has a thickness dl of larger than 0 μm and less than 50 μm. Besides, the cover 12 comprises glass, polymethylmethacrylate (PMMA), plastic, or sapphire, wherein the plastic is exemplified by poly(ether sulfones), polyethylene terephthalate or poly naphthalene two formic acid glycol ester. The solidified protection glue comprises resin and is colorful. For water adsorption, the solidified protection glue 14 has water adsorption of less than 1% at 25° C. in one day. For humidity, the solidified protection glue 14 has humidity of less than 100 g/m² in one day. For hardness, the solidified protection glue 14 has pencil hardness of larger than 450 g in one day. For thermal endurance, the solidified protection glue 14 has thermal endurance of larger than 200° C. in one day. Since the edge of the blind hole 10 is easily-broken positions, the solidified protection glue 14 is coated on the inner sidewall and the inner bottom surface of the blind hole 10 to effectively improve hardness of the blind hole 10 lest the blind hole 10 break.

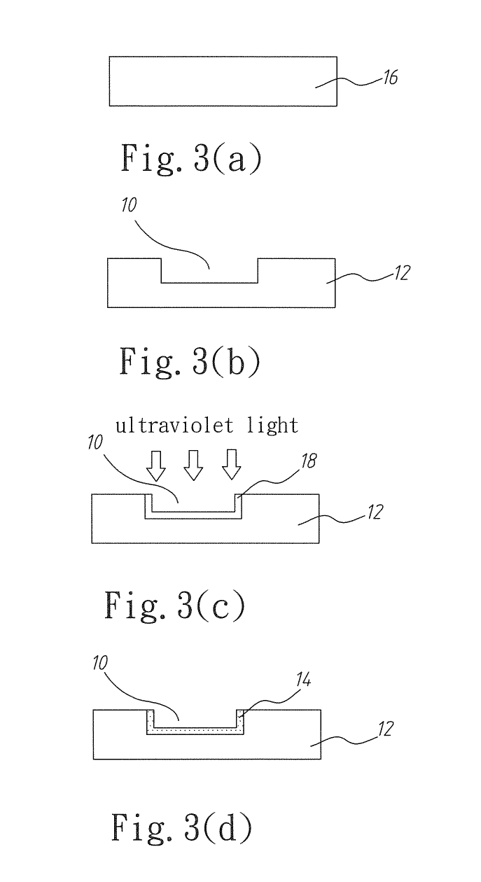

The fabrication process of the first embodiment of the present invention is introduced as below. Refer to FIGS. 3(a)-3(d). Firstly, as shown in FIG. 3(a), a cover plate 16 is provided, wherein the cover plate 16 comprises glass, polymethylmethacrylate, plastic, or sapphire, and the plastic can be poly(ether sulfones), polyethylene terephthalate or poly naphthalene two formic acid glycol ester. Then, as shown in FIG. 3(b), the blind hole 10 is formed in the cover plate 16 using an etching method or a polishing method, thereby forming the cover 12. The material of the cover plate 16 is the same to that of the cover 12. Then, as shown in FIG. 3(c), liquidized protection glue 18 is formed on the inner sidewall and the inner bottom surface of the blind hole 10 using a spray coating method or a dispenser coating method. The liquidized protection glue 18 comprises resin. Finally, as shown in FIG. 3(d), the liquidized protection glue 18 is solidified to form the solidified protection glue 14 by irradiating ultraviolet light or high-temperature treatment. In the first embodiment, the present invention is exemplified by irradiating ultraviolet light.

In addition, the steps of FIGS. 3(a)-3(b) are replaced with a step of directly providing the cover 12 having the blind hole 10 to simplify the fabrication process, as shown in FIG. 3(b).

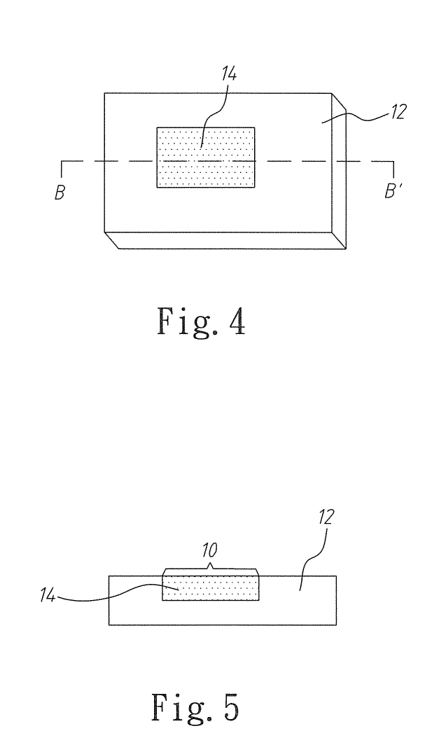

The second embodiment of the present invention is introduced as below. Refer to FIG. 4 and FIG. 5. The enhanced cover of the present invention comprises a cover 12 and solidified protection glue 14, wherein the cover 12 has at least one blind hole 10. The solidified protection glue 14 is arranged on an inner sidewall and an inner bottom surface of the blind hole 10 whereby the blind hole 10 is filled with the solidified protection glue 14. Besides, the cover 12 comprises glass, polymethylmethacrylate (PMMA), plastic, or sapphire, wherein the plastic is exemplified by poly(ether sulfones), polyethylene terephthalate or poly naphthalene two formic acid glycol ester. The solidified protection glue comprises resin and is colorful. For water adsorption, the solidified protection glue 14 has water adsorption of less than 1% at 25□ in one day. For humidity, the solidified protection glue 14 has humidity of less than 100 g/m² in one day. For hardness, the solidified protection glue 14 has pencil hardness of larger than 450 g in one day. For thermal endurance, the solidified protection glue 14 has thermal endurance of larger than 200° C. in one day. Since the edge of the blind hole 10 is easily-broken positions, the solidified protection glue 14 is coated on the inner sidewall and the inner bottom surface of the blind hole 10 to effectively improve hardness of the blind hole 10 lest the blind hole 10 break.

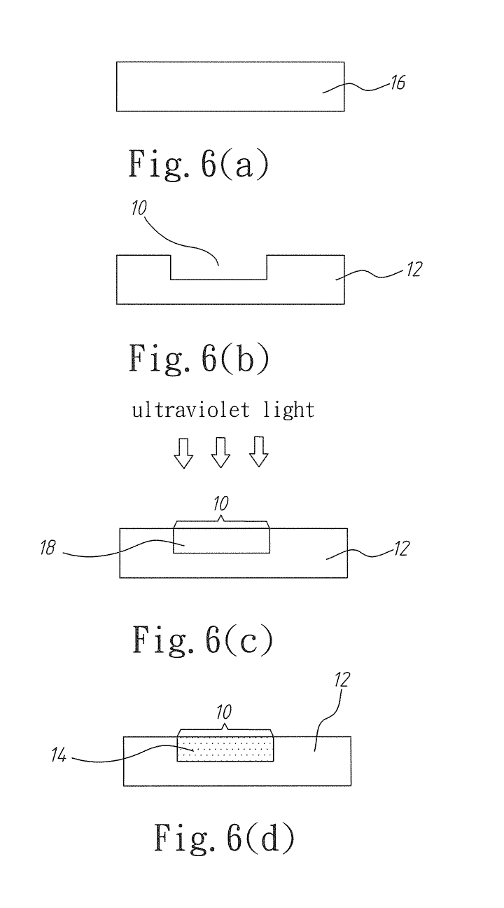

The fabrication process of the second embodiment of the present invention is introduced as below. Refer to FIGS. 6(a)-6(d). Firstly, as shown in FIG. 6(a), a cover plate 16 is provided, wherein the cover plate 16 comprises glass, polymethylmethacrylate, plastic, or sapphire, and the plastic can be poly(ether sulfones), polyethylene terephthalate or poly naphthalene two formic acid glycol ester. Then, as shown in FIG. 6(b), the blind hole 10 is formed in the cover plate 16 using an etching method or a polishing method, thereby forming the cover 12. The material of the cover plate 16 is the same to that of the cover 12. Then, as shown in FIG. 6(c), liquidized protection glue 18 is formed on the inner sidewall and the inner bottom surface of the blind hole 10 using a spray coating method or a dispenser coating method, whereby the blind hole 10 is filled with the liquidized protection glue 18. The liquidized protection glue 18 comprises resin. Finally, as shown in FIG. 6(d), the liquidized protection glue 18 is solidified to form the solidified protection glue 14 by irradiating ultraviolet light or high-temperature treatment. In the second embodiment, the present invention is exemplified by irradiating ultraviolet light.

In addition, the steps of FIGS. 6(a)-6(b) are replaced with a step of directly providing the cover 12 having the blind hole 10 to simplify the fabrication process, as shown in FIG. 6(b).

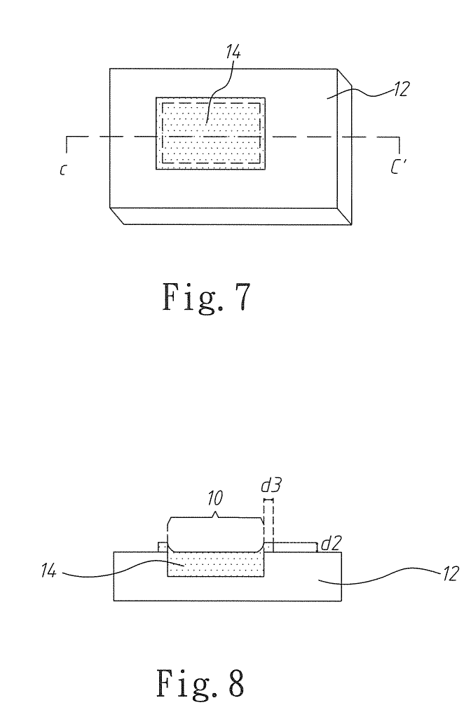

The third embodiment of the present invention is introduced as below. Refer to FIG. 7 and FIG. 8. The enhanced cover of the present invention comprises a cover 12 and solidified protection glue 14, wherein the cover 12 has at least one blind hole 10. The solidified protection glue 14 is arranged on an inner sidewall and an inner bottom surface of the blind hole 10 whereby the blind hole 10 is filled with the solidified protection glue 14, and the solidified protection glue 14 spills from the blind hole 10 and is arranged on the surface of the cover 12. For design, the solidified protection glue 14 arranged on the surface of the cover 12 has a thickness d2 of larger than 0 μm and less than 250 μm, and the solidified protection glue 14 arranged on the surface of the cover 12 has a maximum width d3 of larger than 0 μm and less than 250 μm. Besides, the cover 12 comprises glass, polymethylmethacrylate (PMMA), plastic, or sapphire, wherein the plastic is exemplified by poly(ether sulfones), polyethylene terephthalate or poly naphthalene two formic acid glycol ester. The solidified protection glue comprises resin and is colorful. For water adsorption, the solidified protection glue 14 has water adsorption of less than 1% at 25° C. in one day. For humidity, the solidified protection glue 14 has humidity of less than 100 g/m² in one day. For hardness, the solidified protection glue 14 has pencil hardness of larger than 450 g in one day. For thermal endurance, the solidified protection glue 14 has thermal endurance of larger than 200° C. in one day. Since the edge of the blind hole 10 is easily-broken positions, the solidified protection glue 14 is coated on the inner sidewall and the inner bottom surface of the blind hole 10 to effectively improve hardness of the blind hole 10 lest the blind hole 10 break.

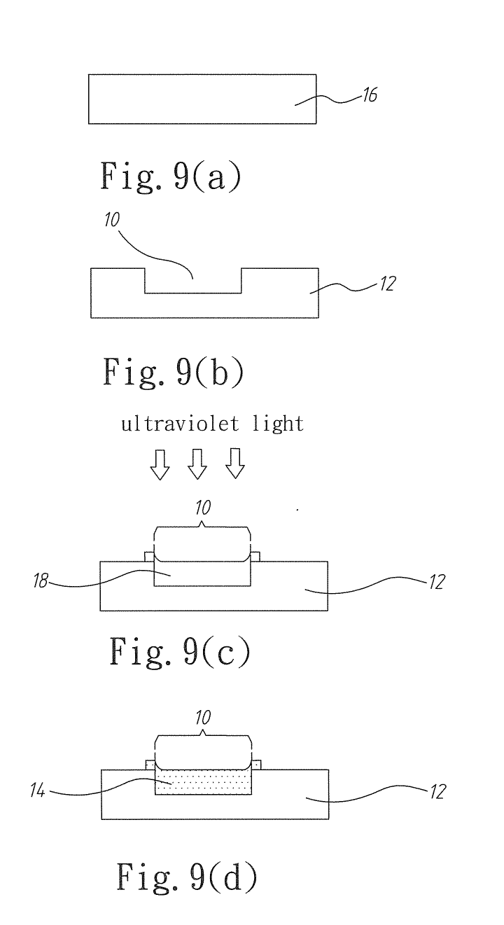

The fabrication process of the third embodiment of the present invention is introduced as below. Refer to FIGS. 9(a)-9(d). Firstly, as shown in FIG. 9(a), a cover plate 16 is provided, wherein the cover plate 16 comprises glass, polymethylmethacrylate, plastic, or sapphire, and the plastic can be poly(ether sulfones), polyethylene terephthalate or poly naphthalene two formic acid glycol ester. Then, as shown in FIG. 9(b), the blind hole 10 is formed in the cover plate 16 using an etching method or a polishing method, thereby forming the cover 12. The material of the cover plate 16 is the same to that of the cover 12. Then, as shown in FIG. 9(c), liquidized protection glue 18 is formed on the inner sidewall and the inner bottom surface of the blind hole 10 using a spray coating method or a dispenser coating method, whereby the blind hole 10 is filled with the liquidized protection glue 18, and the solidified protection glue 14 spills from the blind hole 10 and is arranged on the surface of the cover 12. The liquidized protection glue 18 comprises resin. Finally, as shown in FIG. 9(d), the liquidized protection glue 18 is solidified to form the solidified protection glue 14 by irradiating ultraviolet light or high-temperature treatment. In the third embodiment, the present invention is exemplified by irradiating ultraviolet light.

In addition, the steps of FIGS. 9(a)-9(b) are replaced with a step of directly providing the cover 12 having the blind hole 10 to simplify the fabrication process, as shown in FIG. 9(b).

In conclusion, the present invention coats the blind hole of the cover with the protection glue to improve hardness of the blind hole lest the cover break when the cover drops.

The embodiments described above are only to exemplify the present invention but not to limit the scope of the present invention. Therefore, any equivalent modification or variation according to the shapes, structures, features, or spirit disclosed by the present invention is to be also included within the scope of the present invention.

What is claimed is:

1. An enhanced cover comprising:
a cover having at least one blind hole; and
solidified protection glue arranged on an inner sidewall and an inner bottom surface of said blind hole.

2. The enhanced cover of claim 1, wherein said solidified protection glue arranged on said inner sidewall and said inner bottom surface has a thickness of larger than 0 μm and less than 50 μm.

3. The enhanced cover of claim 1, wherein said blind hole is filled with said solidified protection glue.

4. The enhanced cover of claim 3, wherein said solidified protection glue spills from said blind hole and is arranged on a surface of said cover.

5. The enhanced cover of claim 4, wherein said solidified protection glue arranged on said surface of said cover has a maximum width of larger than 0 μm and less than 250 μm.

6. The enhanced cover of claim 4, wherein said solidified protection glue arranged on said surface of said cover has a thickness of larger than 0 μm and less than 250 μm.

7. The enhanced cover of claim 1, wherein said cover comprises glass, polymethylmethacrylate (PMMA), plastic, or sapphire.

8. The enhanced cover of claim 7, wherein said plastic comprises poly(ether sulfones), polyethylene terephthalate or poly naphthalene two formic acid glycol ester.

9. The enhanced cover of claim 1, wherein said solidified protection glue comprises resin.

10. The enhanced cover of claim 1, wherein said solidified protection glue has water adsorption of less than 1% at 25° C. in one day.

11. The enhanced cover of claim 1, wherein said solidified protection glue has humidity of less than 100 g/m² in one day.

12. The enhanced cover of claim 1, wherein said solidified protection glue has pencil hardness of larger than 450 g in one day.

13. The enhanced cover of claim 1, wherein said solidified protection glue has thermal endurance of larger than 200° C. in one day.

14. A method for fabricating an enhanced cover comprising steps of:
providing a cover having at least one blind hole;
forming liquidized protection glue on an inner sidewall and an inner bottom surface of said blind hole; and
solidifying said liquidized protection glue to form solidified protection glue.

15. The method for fabricating the enhanced cover of claim 14, wherein said solidified protection glue arranged on said inner sidewall and said inner bottom surface has a thickness of larger than 0 μm and less than 50 μm.

16. The method for fabricating the enhanced cover of claim 14, wherein in said step of forming said liquidized protection glue on said inner sidewall and said inner bottom surface, said blind hole is filled with said liquidized protection glue.

17. The method for fabricating the enhanced cover of claim 16, wherein said liquidized protection glue spills from said blind hole and is arranged on a surface of said cover.

18. The method for fabricating the enhanced cover of claim 14, wherein said step of providing said cover further comprises steps of:
providing a cover plate; and
forming said blind hole in said cover plate, thereby forming said cover.

19. The method for fabricating the enhanced cover of claim 18, wherein said blind hole is formed in said cover plate using an etching method or a polishing method.

20. The method for fabricating the enhanced cover of claim 14, wherein said liquidized protection glue is formed on said inner sidewall and said inner bottom surface using a spray coating method or a dispenser coating method.

21. The method for fabricating the enhanced cover of claim 14, wherein said liquidized protection glue is solidified to form said solidified protection glue by irradiating ultraviolet light or high-temperature treatment.
